(19) United States
(12) Patent Application Publication
(10) Pub. No.: US 2010/0200292 A1
(43) Pub. Date: Aug. 12, 2010

(54) SECONDARY CAP

(76) Inventor: Glenn J. Luzzi, Mt. Bethel, PA (US)

Correspondence Address: STROOCK & STROOCK & LAVAN LLP, 180 MAIDEN LANE, NEW YORK, NY, 10038, US

(21) Appl. No.: 12/698,701

(22) Filed: Feb. 2, 2010

Related U.S. Application Data
(60) Provisional application No. 61/150,920, filed on Feb. 9, 2009.

(51) Int. Cl. H02G 15/02

(52) U.S. Cl. 174/74 A

(57) ABSTRACT

A cap assembly for a secondary cable, the assembly including a cap and a ring, the cap having a tapered mouth into which the end of the cable can be inserted, a cavity constructed and arranged to receive an end of a cable, and a plurality of annular ribs extending radially inward, the annular ribs constructed and arranged to create a seal around the cable, the assembly further including a ring coaxially positioned externally around the cap.

### CLAIM OF PRIORITY

This application claims the benefit of priority under 35 U.S.C. §119(e) to U.S. Provisional Application No. 61/150,920, filed Feb. 9, 2009, titled Secondary Cap, which application is also hereby incorporated by reference in its entirety.

### BACKGROUND OF THE INVENTION

Secondary cables on the utility system, as one of ordinary skill in the art would understand, are cables rated 600 volts and below. Often, such cables are connected to a secondary bus or network system. In many instances, the secondary cables are disconnected at one end. These secondary cables often remain energized from the other end. Therefore, the end which is removed are typically capped to prevent electrification of any elements in the structure, such as the structure cover, adjacent lamp posts, grates, the water-soaked concrete of the structure itself, etc. One benefit of capping the end that is removed is preventing splicers or pedestrians contacting both an electrified component and ground from being shocked or electrocuted.

Certain devices currently available to electrically cap or insulate the removed end of a piece of secondary cable from the environment include heat shrinkable caps, tape with which the removed end can be wrapped, size-specific molded rubber caps or combinations thereof, which preferably create a seal around the secondary cable to prevent water or other material from seeping into the device and contacting the removed end. Such products can be effective when properly sized and installed on secondary cables having a round outer perimeter. A potential drawback of these devices can be that if improperly installed, the seal between the device and secondary cable can be compromised, and water may seep into the device and contact the conductor of the secondary cable, which is energized. If the material is conductive, such as water, an electrical current may travel, via the water, and electrify structure components.

Furthermore, the seal between the device and secondary cable may also be compromised if the surface of the secondary cable is damaged or if the secondary cable contains extruded-in phase markers, which often extend outward, for example, radially outward, from the secondary cable. Certain secondary cables currently available have one, two or three extruded-in phase markers.

Accordingly, it is desirable to provide a device that overcomes these and other drawbacks of the current methods and products.

### SUMMARY OF THE INVENTION

The present invention is directed towards a device and/or assembly for covering and sealing the removed end of a secondary cable. In accordance with an exemplary embodiment, the device includes a cap, preferably a rubber cap, more preferably a molded rubber cap that can be produced, preferably mass produced, for example, in a factory. In accordance with an exemplary embodiment, the present invention is directed towards a cap assembly comprising a cap having a cavity constructed and arranged to receive an end of a cable. In a preferred embodiment, the cap includes a plurality of annular ribs extending radially inward so as to create a seal around the cable. In a preferred embodiment the cap also includes a tapered mouth into which the end of the cable can be inserted. In a preferred embodiment the cap assembly also includes a ring coaxially positioned externally around the cap, and in a preferred embodiment the cap has a first Young's modulus and the external ring has a second Young's modulus higher than the first Young's modulus.

Other objects and features of the present invention will become apparent from the following detailed description, considered in conjunction with the accompanying drawing figures. It is to be understood, however, that the drawings are designed solely for the purpose of illustration and not as a definition of the limits of the invention, for which reference should be made to the appended claims.

### BRIEF DESCRIPTION OF THE DRAWINGS

The particular features and advantages of the invention as well as other objects will become apparent from the following description taken in connection with the accompanying drawings, in which:

FIG. 1 is a side view of a secondary cap assembly in accordance with an embodiment of the invention, with the secondary cap assembly shown installed on a cable;

FIG. 2 is side view of the secondary cap assembly of FIG. 1;

FIG. 3 is a side view of a secondary cap in accordance with an embodiment of the invention;

FIG. 4 is an end view of the secondary cap of FIG. 3;

FIG. 5 is a side view of a ring for use with a secondary cap in accordance with an embodiment of the invention;

FIG. 6 is a side view of a cable;

FIG. 7 is an end view of the cable of FIG. 6.

### DESCRIPTION OF EXEMPLARY EMBODIMENTS

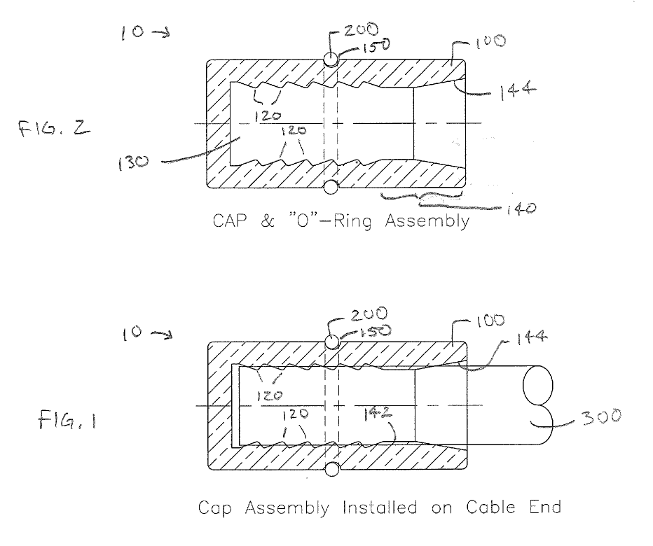

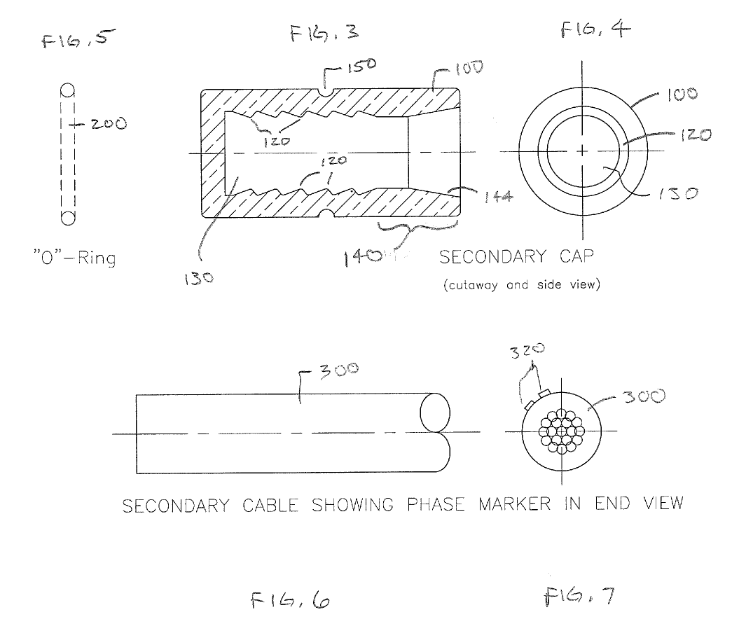

Reference is made to FIGS. 1-5, wherein an embodiment of a secondary cap assembly 10 in accordance with an embodiment of the present invention is shown. In FIG. 1, the cap assembly 10 is shown installed on a cable 300. FIGS. 2-5 shows the cap assembly 10 without the cable 300. FIGS. 6 and 7 show a secondary cable 300.

As seen in FIGS. 1-5, the cap assembly 10 includes a cap 100 that includes a groove 150 preferably shaped and sized to receive ring 200. FIGS. 2-4 show the cap assembly 10 without the cable 300 and illustrates that cap 100 can include a cavity 130 into which the cable 300 can be inserted. Cap 100 preferably includes one or more ribs 120 projecting into the cavity 130. Preferably, the inner diameter of the ribs 120 is equal to or less than the outer diameter of the cable 300, as shown in FIG. 1. Accordingly, when the cable 300 is inserted into the cavity 130, the ribs 120 can exert pressure and more preferably sealingly contact onto the cable 300. Referring to FIG. 1, the cable 300 can have a flexible outer wall and/or the ribs 120 can comprise a flexible material such that the outer wall of the cable 300 and/or the ribs 120 can become deformed and contract where the ribs 120 contact the outer wall of the cable 300 so that the ribs 120 can conform to the outer surface of the cable 300.

Referring to FIGS. 1-4, the ribs 120 can comprise annular rings projecting inward into cavity 130. However, it is to be understood that one or more ribs 120 can include a plurality of bumps or other structures of any shape and size extending inward into cavity 130 without deviating from the scope of the invention. In the embodiment shown, each rib 120 preferably creates a seal, preferably a water-proof seal, with the cable 300. By providing a plurality of annular ribs 120, the integrity of the seal between the cap 100 and the cable 300 can be enhanced. For example, if the outer surface of the cable is damaged or deformed or if a rib 120 is damaged, the seal between one or more ribs 120 and cable 300 may be compromised. Preferably in such a situation, the seal between at least one of the remaining ribs 120 and the cable 300 will not be compromised, and the seal between the cap 100 and cable 300 can be maintained, thus preventing water and/or other material from contacting the removed end of the cable 300, which may be energized. In accordance with the embodiment shown, the cap 100 can include five annular ribs 120. It is to be understood that the number of ribs 120 can be varied as a matter of application specific design choice and does not narrow the scope of the invention in any way.

Cable 300 may include one or more phase markers, for example, extruded-in phase markers. Referring to FIG. 7, the illustrated embodiment of cable 300 includes two phase markers 320 extending outward from the cable 300. Such phase markers 320 may compromise the seal between the cable 300 and a cap having a single or no annular ribs. The illustrated embodiment of cap 100, in contrast, compensates for the potential breach in the seal between the cap and the cable having phase markers 320. More specifically, the cap 100 of the present invention preferably includes multiple ribs 120 in order to compensate for the potential breach in the seal between the ribs 120 and the cable 300 because of the phase markers 320, thus maintaining a seal between the cap 100 and cable 300. As describe below, ring 200 of the cap assembly 10 also helps ensure a tight seal between the cap and the cable having phase markers by providing increased hoop force between at least one rib 120 and the cable 300.

In accordance with an exemplary embodiment cap 100 is molded of a rubber having a Young's modulus that is low enough to enhance the ability of the annular ribs 120 to conform to the shape of the cable 300, such as variations in the cable diameter, imperfections on the surface of the cable 300, areas of surface damage of the cable 300, etc. In a preferred embodiment, cap 100 and/or ring 200 are formed of any suitable elastomeric material, such as EPDM, Nitrile, Neoprene, or the like, or any combination thereof.

In accordance with the embodiment shown in FIGS. 1-4, the cap 100 of cap assembly 10 includes a tapered lead-in portion 140, which preferably facilitates easier positioning of the cable 300 within cap 100. Referring to FIG. 1, mouth 144 of the lead-in portion 140 can be wider than the cable 300, wherein the mouth 144 has an inner diameter greater than the outer diameter of the cable 300. Therefore, the person placing the cap 100 onto the end of the cable 300 need not be precise for the end of the cable 300 to be received by the cap 100.

The narrowest part 142 of the lead-in portion 140 is preferably narrower than the cable 300, wherein the inner diameter of the narrowest part 142 is less than the outer diameter of the cable 300. Accordingly, the narrowest part 142 and/or the cable 300 are preferably deformed so as to create a seal between the narrowest part 142 and the cable 300 to secure the cap 100 in place with respect to the cable 300.

The ribs 120 can be angled towards the mouth 142, can be angled away from the mouth 142, or could be angled perpendicular to the mouth 142 as a matter of design choice. As illustrated in FIGS. 1-3, in a preferred embodiment the ribs 120 are angled away from the mouth 142, which can provide the seal between the ribs 120 and the cable 300 while at the same time making the cap 100 easier to install on the cable 300 as compared to if the ribs were perpendicular or angled towards the mouth 142. The ribs 120 can permit the use of the same cap on different sixed cables, which is an improvement of the prior art size-specific caps, and which in turn permits decreased manufacturing and inventory needs and ease of installation.

Referring to FIGS. 1-5, cap assembly 10 also preferably includes an external ring 200, for example, an “O-ring,” which can be positioned around the exterior of the cap 100. Preferably, ring 200 has a Young's modulus that is greater than that of the cap 100, and has limited flexibility such that if the cap 100 expands radially outward, for example, by a cable having a greater outer diameter than the inner diameter of the cap 100, the ring 200 can prevent the cap 100 proximate the ring 200 from expanding beyond the inner diameter of the ring 200. In a preferred embodiment, outer ring 200 provides a higher hoop force in a limited segment of the cap 100 so as to ensure that the inner rib (or ribs) 120 that is directly under (or proximate) the ring 200 adequately conforms to the cable 300 and/or the phase markers 320 on the cable 300 to help ensure a water-tight seal between the cap 100 and the cable 300. While the cap assembly 10 is shown with a single ring 200, the cap assembly can include any number of rings without departing from the scope of the invention. In addition, while the ring 200 is shown as having a width substantially equal to that of a rib 120, and is shown as being positioned directly over a rib 120, other sized rings and/or ribs are contemplated herein, and the positioning of the ring relative to the ribs and/or mouth of the cap can be altered without departing from the scope of the invention.

Referring to FIGS. 1-3, the cap 100 can include a groove 150 preferably shaped and sized to receive ring 200, which preferably prevents the inadvertent dislocation or movement of ring 200 relative to cap 100. The groove 150 can be molded into the cap 100. However, it is to be understood that the groove 150 can be formed by a variety of methods, such as being cut out from the cap 100, without deviating from the scope of the invention. In addition, while a groove 150 is shown, other means of maintaining ring 200 relative to cap 100 are contemplated without departing from the scope of the invention. For example, the cap 100 can be formed with integrally formed raised members (not shown) to help maintain ring 200 in place. Once assembled, as shown in FIGS. 1-2, ring 200 can apply a force on the cap 100 radially inward, for example, to limit the radial expansion of the cap 100. Preferably, the ring 200 provides a hoop force, more preferably in a limited location proximate the ring 200, to enhance the seal created between the cap 100 and the cable 300. The hoop force of the stiffer ring 200 may facilitate cap 100, having the lower modulus, to better conform and seal against the cable 300, for example, particularly with cables having rigid phase markers 320.

The examples provided are merely exemplary, as a matter of application specific to design choice, and should not be construed to limit the scope of the invention in any way. Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. For example, the material of the body and/or ring, the number of ribs and/or rings, the size, position and/or shape of the ribs, ring and/or the lead-in portion, the type of cable with which the cap 10 can be used, including the flexibility of the cable, the number and type of phase markers, etc. can be varied without deviating from the scope of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

I claim:

1. A cap assembly for a secondary cable, the cap assembly comprising:
a cap and a ring;
the cap formed of an elastomeric material and having an outer surface comprising a groove, an open end having a tapered opening, a closed end, and an inner cavity, the inner cavity constructed and arranged to receive a cable therein, the inner cavity having a plurality of annular ribs extending radially inward and constructed and arranged to sealingly contact the cable when inserted within the cavity; and
the ring formed of an elastomeric material and having an inner diameter less than the outer surface of the cap, the ring constructed to be positionable within the groove,
wherein the cap is formed of an elastomeric material having a first Young's modulus and the ring is formed of an elastomeric material having a second Young's modulus higher than the first Young's modulus.

2. The cap assembly of claim 1, wherein the tapered opening has a inner diameter larger than the outer diameter of the cable.

3. The cap assembly of claim 1, wherein the inner cavity comprises a portion that has an inner diameter less than the outer diameter of the cable.

4. The cap assembly of claim 1, wherein one or more of the plurality of ribs are angled towards the closed end of the cap.

5. The cap assembly of claim 1, wherein the groove is formed directly over one of the plurality of ribs.

6. The cap assembly of claim 1, wherein the ring has a width substantially equal to that of one of the plurality of ribs.

7. The cap assembly of claim 1, wherein the ring is constructed and arranged to provide an increased hoop force on at least one of the plurality of ribs.

8. The cap assembly of claim 1, wherein the ring is an O-ring.

9. A cap assembly for a secondary cable, the cap assembly comprising:
a cap and a ring;
the cap formed of an elastomeric material and having an outer surface, an open end, a closed end, and an inner cavity, the inner cavity constructed and arranged to receive a cable therein, the inner cavity having a plurality of annular ribs extending radially inward and constructed and arranged to sealingly contact the cable when inserted within the cavity; and
the ring formed of an elastomeric material and positionable on the cap and having an inner diameter less than the outer surface of the cap.

10. The cap assembly of claim 9, wherein the cap is formed of a material having a first Young's modulus and the ring is formed of a material having a second Young's modulus higher than the first Young's modulus.

11. The cap assembly of claim 9, wherein the outer surface of the cap includes a groove, and wherein the ring is adapted to be positionable within the groove.

12. The cap assembly of claim 11, wherein the groove is formed in radial alignment with one of the plurality of ribs.

13. The cap assembly of claim 9, wherein one or more of the plurality of ribs are angled towards the closed end of the cap.

14. The cap assembly of claim 9, wherein the groove is formed directly over one of the plurality of ribs.

15. The cap assembly of claim 9, wherein the ring has a width substantially equal to that of one of the plurality of ribs.

16. The cap assembly of claim 9, wherein the ring is constructed and arranged to provide an increased hoop force on at least one of the plurality of ribs.

17. A cap for a secondary cable, the cap formed of an elastomeric material and comprising:
an open end, a closed end, an outer surface and an inner cavity, the inner cavity constructed and arranged to receive an end of a cable, the inner cavity having a plurality of annular ribs extending radially inward to contact the cable.

18. The cap of claim 17, wherein the open end includes a tapered opening having an inner diameter larger than the outer diameter of the cable.

19. The cap assembly of claim 17, wherein the inner cavity comprises a portion that has an inner diameter less than the outer diameter of the cable.

20. The cap assembly of claim 17, wherein one or more of the plurality of ribs are angled towards the closed end of the cap.
